(19) United States
(12) Patent Application Publication
(10) Pub. No.: US 2024/0375374 A1
(43) Pub. Date: Nov. 14, 2024

(54) MOLDABLE NONWOVEN COMPOSITE

(71) Applicant: Milliken & Company, Spartanburg, SC (US)

(72) Inventors: Kazuaki Shibata, Simpsonville, SC (US); Heather Pretorius, Greenville, SC (US)

(21) Appl. No.: 18/657,238

(22) Filed: May 7, 2024

Related U.S. Application Data
(60) Provisional application No. 63/501,504, filed on May 11, 2023.

(51) Int. Cl. B32B 5/26; B32B 5/02; B32B 7/12; B32B 27/12

(52) U.S. Cl. CPC B32B 5/266; B32B 5/022; B32B 7/12; B32B 27/12; B32B 2255/02; B32B 2255/26; B32B 2262/0276; B32B 2305/20; B32B 2307/102; B32B 2307/718; B32B 2307/7376

(57) ABSTRACT

A moldable nonwoven composite contains a nonwoven face layer, an adhesive layer, a sound absorbing nonwoven layer, and a backing layer. The upper surface of the nonwoven face layer forms the first side of the moldable nonwoven composite. The nonwoven face layer contains between about 80 and 95% wt first polyester terephthalate fibers and between about 5 and 20% wt first low melt polyester fibers. The adhesive layer contains a first low melt polyester adhesive. The sound absorbing nonwoven layer contains between about 40-90% wt second polyester terephthalate fibers and between about 10 and 60% wt second low melt polyester fibers. The lower surface of the polymer backing layer forms the second side of the moldable nonwoven composite. The polymer backing layer contains a second low melt polyester adhesive. The entire moldable nonwoven composite essentially consists of polyester, defined as being as least 95% wt polyester.

### RELATED APPLICATION

This application claims priority to co-pending U.S. provisional patent application 63/501,504 filed on May 11, 2023 which is herein incorporated in its entirety.

### TECHNICAL FIELD OF THE INVENTION

The invention provides a moldable nonwoven composite having good physical properties.

### BACKGROUND

There are a number of products in various industries, including automotive, office and home furnishings, construction, and others; that require materials having a z-direction thickness to provide both structural strength as well as thermal, sound insulation, aesthetic, and/or other performance features. In many of these applications it is also required that the material be thermoformable to a specified shape and rigidity. In the automotive industry these products often are used for shielding applications such as noise and thermal barriers in automotive hood liners, underbody shields, firewall barriers, floor liners, carpeting, and trunk liners.

Composite materials used in automotive applications like package shelves, door panels or headliners are often produced via heating and then cold pressing structural nonwoven composite layers bound by a thermoplastic binder fiber to a decorative layer.

It would be preferably to be able to create an easy to manufacture and use composite that used thermoplastic materials and would be more recyclable than other products currently in the marketplace.

### BRIEF SUMMARY OF THE INVENTION

The invention relates to a moldable nonwoven composite contains a nonwoven face layer, an adhesive layer, a sound absorbing nonwoven layer, and a backing layer. The upper surface of the nonwoven face layer forms the first side of the moldable nonwoven composite. The nonwoven face layer contains between about 80 and 95% wt first polyester terephthalate fibers and between about 5 and 20% wt first low melt polyester fibers and has a weight of between about 150 and 750 g/m². The adhesive layer contains a first low melt polyester adhesive and has a weight of between about 80 and 400 g/m². The sound absorbing nonwoven layer contains between about 40-90% wt second polyester terephthalate fibers and between about 10 and 60% wt second low melt polyester fibers and has a weight of between about 150 and 1,500 g/m². The lower surface of the polymer backing layer forms the second side of the moldable nonwoven composite. The polymer backing layer contains a second low melt polyester adhesive and has a weight of between about 80 and 1,000 g/m². The entire moldable nonwoven composite essentially consists of polyester, defined as being as least 95% wt polyester.

In another embodiment, a moldable nonwoven composite contains a nonwoven face layer, a sound absorbing nonwoven layer, and a backing layer. The upper surface of the nonwoven face layer forms the first side of the moldable nonwoven composite. The nonwoven face layer contains between about 80 and 95% wt first polyester terephthalate fibers and between about 5 and 20% wt first low melt polyester fibers and has a weight of between about 150 and 750 g/m². The sound absorbing nonwoven layer contains between about 40-90% wt second polyester terephthalate fibers and between about 10 and 60% wt second low melt polyester fibers and has a weight of between about 150 and 1,500 g/m². The lower surface of the polymer backing layer forms the second side of the moldable nonwoven composite. The polymer backing layer contains a second low melt polyester adhesive and has a weight of between about 80 and 1,000 g/m². The entire moldable nonwoven composite essentially consists of polyester, defined as being as least 95% wt polyester.

In another embodiment, a moldable nonwoven composite contains a nonwoven face layer, an adhesive layer, and a sound absorbing nonwoven layer. The upper surface of the nonwoven face layer forms the first side of the moldable nonwoven composite. The nonwoven face layer contains between about 80 and 95% wt first polyester terephthalate fibers and between about 5 and 20% wt first low melt polyester fibers and has a weight of between about 150 and 750 g/m². The adhesive layer contains a first low melt polyester adhesive and has a weight of between about 80 and 400 g/m². The sound absorbing nonwoven layer contains between about 40-90% wt second polyester terephthalate fibers and between about 10 and 60% wt second low melt polyester fibers and has a weight of between about 150 and 1,500 g/m². The lower surface of the sound absorbing nonwoven layer forms the second side of the moldable nonwoven composite. The entire moldable nonwoven composite essentially consists of polyester, defined as being as least 95% wt polyester.

### BRIEF DESCRIPTION OF THE FIGURES

An embodiment of the present invention will now be described by way of example, with reference to the accompanying drawings.

FIG. 1 illustrates schematically a cross-section of one embodiment of the moldable nonwoven composite having a nonwoven face layer, an adhesive layer, a sound absorbing layer, and a polymer backing layer.

FIG. 2 illustrates schematically a cross-section of one embodiment of the moldable nonwoven composite having a nonwoven face layer, a sound absorbing layer, and a polymer backing layer.

FIG. 3 illustrates schematically a cross-section of one embodiment of the moldable nonwoven composite having a nonwoven face layer, an adhesive layer, and a sound absorbing layer.

### DETAILED DESCRIPTION OF THE INVENTION

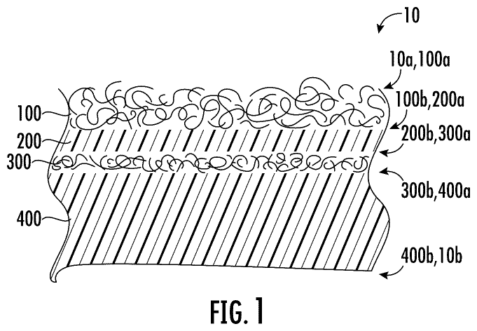

Referring to FIG. 1, there is shown one embodiment of a moldable nonwoven composite 10 having a first side 10a and a second side 10b. The moldable nonwoven composite 10 contains a nonwoven face layer 100, an adhesive layer 200, a sound absorbing layer 300, and a polymer backing layer 400. The nonwoven face layer 100 contains an upper surface 100a and a lower surface 100b. The upper surface 100a of the nonwoven face layer 100 forms the first side 10a of the moldable nonwoven composite 10. The adhesive layer 200 contains an upper surface 200a and a lower surface 200b. The upper surface 200a of the adhesive layer 200 faces, is adjacent to, and is preferably touching and contiguous to the lower surface 100b of the nonwoven face layer 100. The sound absorbing nonwoven layer 300 contains an upper surface 300a and a lower surface 300b. The upper surface 300a of the sound absorbing nonwoven layer 300 faces, is adjacent to, and is preferably touching and contiguous to the lower surface 200b of the adhesive layer 200. The polymer backing layer 400 contains an upper surface 400a and a lower surface 400b. The upper surface 400a of the polymer backing layer 400 faces, is adjacent to, and is preferably touching and contiguous to the lower surface 300b of the sound absorbing nonwoven layer 300. The lower surface 400b of the polymer backing layer 400 forms the second side 10b of the moldable nonwoven composite 10. Once the moldable nonwoven composite 10 is molded under heat and pressure, it becomes a molded composite.

The entire moldable nonwoven composite essentially consists of polyester. Essentially consists of is defined as being as least 95% wt. Monomaterial compositions (material comprising the same polymer type) tend to eliminate chemical compatibility/bonding issues. In addition, constructions using the same material type can be more easily recycled and reused at end of life and also allows for the scraps produced during manufacture to be more easily recycled. Polyester is preferred as it has a high melt point as well as durability. Recycled polymer material may also be used for some end products to help make the product more environmentally friendly.

In one embodiment, the areal weight of the moldable nonwoven composite 10 is between about 460 and 3650 g/m², more preferably between about 550 and 1800 g/m².

The nonwoven fabric layer 100 preferably forms the surface that a user would interact with which is sometimes referred to as the “A” or face surface. In some embodiments, the upper surface 100a of the nonwoven fabric layer 100 has a carpet like appearance with the fibers from the nonwoven layer 100 extending outwards to give a pile look to the layer. This may be preferred in embodiments where the moldable nonwoven composite was used in the flooring area of a vehicle to give the flooring a more traditional carpeted look. In other embodiments, the upper surface 100a of the nonwoven face layer has a more smoothed appearance. This may be preferable for applications such as a trunk liner where having a pile might make cleaning more difficult.

In one embodiment, the average thickness of the nonwoven face layer 100 is between about 1 mm and 10 mm, more preferably between about 2 mm and 7 mm. The thickness is defined as the distance between the first surface 100a and the second surface 100b of the nonwoven face layer 100 measured in 5-10 locations and averaged. The nonwoven face layer 100 has a weight of between about 150 and 750 g/m², more preferably between about 250 and 550 g/m².

The nonwoven face layer 100 contains between about 80 and 95% wt first polyester terephthalate fibers and between about 5 and 20% wt first low melt polyester fibers. In a more preferred embodiment, the nonwoven fabric layer 100 contains between about 85 and 92% wt first polyester terephthalate (PET) fibers and between about 8 and 15% wt first low melt polyester fibers. Preferably, essentially all of the fibers in the nonwoven face layer 100 are polyester (essentially all meaning at least about 95% wt). The fibers in the in the nonwoven face layer 100 are preferably staple fibers. Preferably, the first PET fibers have a denier of between about 3 and 15 and the first low melt polyester fibers preferably have a denier of between about 1.5 and 4. “Low melt”, in this application is defined to mean a melting temperature of less than about 200° C. In another embodiment, the low melt fibers and or adhesives may have a melting temperature of less than about 140° C. or less than 130° C. In one embodiment, first PET fibers have a melting temperature of at least twice the melting temperature of the first low melt polyester fibers. This difference in melting temperatures allows for good moldability and adhesion (through the low melt fibers) while maintaining the strength of the nonwoven layer (through the PET fibers).

The sound absorbing nonwoven layer 300 has an upper surface 300a and a lower surface 300b. In one embodiment, the average thickness of the nonwoven face layer 300 is between about 1 mm and 15 mm, more preferably between about 2 mm and 10 mm. The thickness is defined as the distance between the first surface 300a and the second surface 300b of the sound absorbing nonwoven layer 300 measured in 5-10 locations and averaged. The sound absorbing nonwoven layer 300 has a weight of between about 150 and 1,500 g/m², more preferably between about 300 and 1,000 g/m². In one embodiment, the sound absorbing nonwoven layer 300 has a higher density than the nonwoven face layer 100. In one embodiment, the sound absorbing nonwoven layer 300 has a greater average thickness than the nonwoven face layer 100. In another embodiment, the nonwoven face layer 100 has a greater average thickness than the sound absorbing nonwoven layer 300.

The sound absorbing nonwoven layer 300 contains between about 40 and 90% wt second polyester terephthalate fibers and between about 10 and 60% wt second low melt polyester fibers. In a more preferred embodiment, the sound absorbing nonwoven layer 300 contains between about 60 and 80% wt second polyester terephthalate (PET) fibers and between about 20 and 40% wt second low melt polyester fibers. Preferably, essentially all of the fibers in the sound absorbing nonwoven layer 300 are polyester (essentially all meaning at least about 95% wt). The fibers in the in the sound absorbing nonwoven layer 300 are preferably staple fibers. Preferably, the second PET fibers have a denier of between about 3 and 15 and the second low melt polyester fibers preferably have a denier of between about 1.5 and 4. In one embodiment, second PET fibers have a melting temperature of at least twice the melting temperature of the second low melt polyester fibers.

Utilizing these two nonwoven layers 100, 300 in the composite 10 instead of a single nonwoven layer may have some advantages in the finished product, for example, the combination of the two nonwoven layers may produce a superior sound absorption. The sound absorption can be tailored by selecting the different fiber sizes and densities of the two layers 100, 300.

Referring back to FIG. 1, the adhesive layer 200 has an upper surface 200a and a lower surface 200b and being located on the lower surface 100b of the nonwoven face layer 100a. The adhesive layer 200 contains a first low melt polyester adhesive and has a weight of between about 80 and 400 g/m². The adhesive layer may be incorporated into the moldable nonwoven composite in any suitable method. The adhesive layer 200 may be applied to the nonwoven face layer 100 or the sound absorbing nonwoven layer 400 as a liquid or molten coating or may be introduced as a free-standing film. Some examples of coating techniques are, but are not limited to, extrusion coating, solvent coating, gravure coating, knife coating, curtain coating, dip coating. Preferably, the adhesive layer 200 is extrusion coated onto the nonwoven fabric layer 100 and/or the sound absorbing nonwoven layer 300. Preferably, once the adhesive layer is added, the sandwich of the nonwoven face layer 100, the adhesive layer 200, and the sound absorbing nonwoven layer 300 is run through a nip with heat and/or pressure to adhere the layers together. Preferably, once adhered, the low melt polyester adhesive of the adhesive layer extends (or migrates) at least partially into the nonwoven face layer 100 and/or the sound absorbing nonwoven layer 300. This helps ensure a good bond between the two nonwoven layers 100, 300.

The polymer backing layer 400 has an upper surface 400a and a lower surface 400b and the lower surface 400b of the polymer backing layer 400 forms the second side of the composite 10. The polymer backing layer 400 contains a second low melt polyester adhesive and has a weight of between about 80 and 1,000 g/m². This second low melt polyester adhesive may be the same as the first low melt polyester adhesive or may be a different polyester. The polymer backing layer 400 may be incorporated into the moldable nonwoven composite in any suitable method. The adhesive layer 200 may be applied to the sound absorbing nonwoven layer 300 as a liquid or molten coating or may be introduced as a free-standing film. Some examples of coating techniques are, but are not limited to, extrusion coating, solvent coating, gravure coating, knife coating, curtain coating, dip coating. Preferably, the polymer backing layer 400 is extrusion coated onto the sound absorbing nonwoven layer 300. Preferably, once the polymer backing layer 400 is added, the entire sandwich of the composite is run through a nip with heat and/or pressure to adhere the layers together. Preferably, once adhered, the low melt polyester adhesive of the adhesive layer extends (or migrates) at least partially into the sound absorbing nonwoven layer 300. This helps ensure a good bond between the nonwoven layer 300 and the polymer backing layer 400.

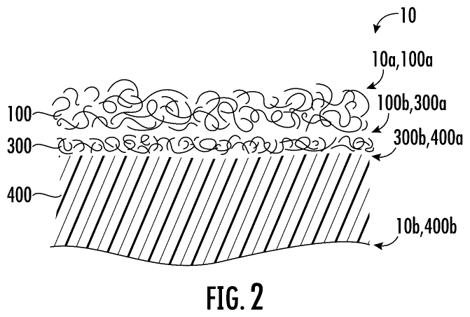

Referring to FIG. 2, there is shown another embodiment of the invention similar to the embodiment shown in FIG. 1, without the adhesive layer. In this embodiment, a moldable nonwoven composite 10 has a first side 10a and a second side 10b. The moldable nonwoven composite 10 contains a nonwoven face layer 100, a sound absorbing layer 300, and a polymer backing layer 400. The nonwoven face layer 100 contains an upper surface 100a and a lower surface 100b. The upper surface 100a of the nonwoven face layer 100 forms the first side 10a of the moldable nonwoven composite 10. The sound absorbing nonwoven layer 300 contains an upper surface 300a and a lower surface 300b. The upper surface 300a of the sound absorbing nonwoven layer 300 faces, is adjacent to, and is preferably touching and contiguous to the lower surface 100b of the nonwoven face layer 100. The polymer backing layer 400 contains an upper surface 400a and a lower surface 400b. The upper surface 400a of the polymer backing layer 400 faces, is adjacent to, and is preferably touching and contiguous to the lower surface 300b of the sound absorbing nonwoven layer 300. The lower surface 400b of the polymer backing layer 400 forms the second side 10b of the moldable nonwoven composite 10. Once the moldable nonwoven composite 10 is molded under heat and pressure, it becomes a molded composite. In this embodiment, as there is no adhesive between the nonwoven face layer 100 and the sound absorbing nonwoven layer 300, the first and second low melt polyester fibers help to adhere the two nonwoven layers 100, 300 together.

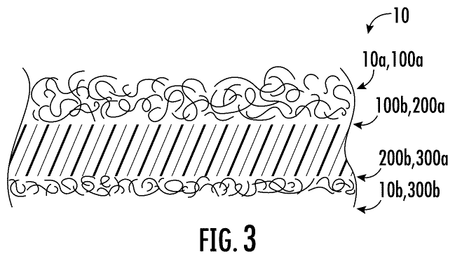

Referring to FIG. 3, there is shown another embodiment of the invention similar to the embodiment shown in FIG. 1, without the polymer backing layer. In this embodiment, a moldable nonwoven composite 10 has a first side 10a and a second side 10b. The moldable nonwoven composite 10 contains a nonwoven face layer 100, an adhesive layer 200, and a sound absorbing layer 300. The nonwoven face layer 100 contains an upper surface 100a and a lower surface 100b. The upper surface 100a of the nonwoven face layer 100 forms the first side 10a of the moldable nonwoven composite 10. The adhesive layer 200 contains an upper surface 200a and a lower surface 200b. The upper surface 200a of the adhesive layer 200 faces, is adjacent to, and is preferably touching and contiguous to the lower surface 100b of the nonwoven face layer 100. The sound absorbing nonwoven layer 300 contains an upper surface 300a and a lower surface 300b. The upper surface 300a of the sound absorbing nonwoven layer 300 faces, is adjacent to, and is preferably touching and contiguous to the lower surface 200b of the adhesive layer 200. The lower surface 300b of the sound absorbing nonwoven layer 300 forms the second side 10b of the moldable nonwoven composite 10. Once the moldable nonwoven composite 10 is molded under heat and pressure, it becomes a molded composite.

The moldable nonwoven composite 10 is preferably still flexible. This means that the moldable nonwoven composite 10 is able to be completely folded onto itself (a 180 degree fold) and then can be unfolded without any permanent changes in appearance or physical properties. This flexibility is important for the composite to be used in certain applications like in molded parts for cars.

The moldable nonwoven composite 10 may be used as is or may be further molded into a three-dimensional shape using heat and/or pressure. In one embodiment, the moldable nonwoven composite 10 is cut into a desired shape and size and the molded. To form the moldable nonwoven composite 10 into a molded composite, heat and optionally pressure is applied to the moldable nonwoven composite 10 heating the composite to a temperature of at least about 150° C. this serves to melt the low melt polyesters in the different layers.

In the molded composite, at least a portion of the binder fibers may still have a fibrous shape with the other fibers melting into binder material (the binder material typically coating the PET fibers or forming adhesive blobs).

The molded nonwoven composite preferably becomes more rigid (also referred to as less flexible) than the moldable nonwoven composite 10. Preferably, the molded nonwoven composite is stiff enough to support its own weight, hold its own shape, and may even be stiff enough to support additional weight without changing its shape.

The composite 10 may also contain any additional layers for physical or aesthetic purposes. Suitable additional layers include, but are not limited to, a nonwoven fabric, a woven fabric, a knitted fabric, a foam layer, a film, a paper layer, an adhesive-backed layer, a foil, a mesh, an elastic fabric (i.e., any of the above-described woven, knitted or nonwoven fabrics having elastic properties), an apertured web, an adhesive-backed layer, or any combination thereof. Other suitable additional layers include, but are not limited to, a color-containing layer (e.g., a print layer); one or more additional sub-micron fiber layers having a distinct average fiber diameter and/or physical composition; one or more secondary fine fiber layers for additional insulation performance (such as a melt-blown web or a fiberglass fabric); foams; layers of particles; foil layers; films; decorative fabric layers; membranes (i.e., films with controlled permeability, such as dialysis membranes, reverse osmosis membranes, etc.); netting; mesh; wiring and tubing networks (i.e., layers of wires for conveying electricity or groups of tubes/pipes for conveying various fluids, such as wiring networks for heating blankets, and tubing networks for coolant flow through cooling blankets); or a combination thereof. The additional layers may be on either or both sides of the nonwoven composite. For example, a textile may be applied to one side of the nonwoven composite using an optional adhesive layer to form an aesthetic surface for an end use such as certain automobile applications. In a preferred embodiment, any additional layers or materials added to the composite are also essentially all polyester to help with the recyclability of the composite.

The composite may further comprise one or more attachment devices to enable the composite to be attached to a substrate or other surface. In addition to adhesives, other attachment devices may be used such as mechanical fasteners like screws, nails, clips, staples, stitching, thread, hook and loop materials, etc.

The one or more attachment devices may be used to attach the composite to a variety of substrates. Exemplary substrates include, but are not limited to, a vehicle component; an interior of a vehicle (i.e., the passenger compartment, the motor compartment, the trunk, etc.); a wall of a building (i.e., interior wall surface or exterior wall surface); a ceiling of a building (i.e., interior ceiling surface or exterior ceiling surface); a building material for forming a wall or ceiling of a building (e.g., a ceiling tile, wood component, gypsum board, etc.); a room partition; a metal sheet; a glass substrate; a door; a window; a machinery component; an appliance component (i.e., interior appliance surface or exterior appliance surface); a surface of a pipe or hose; a computer or electronic component; a sound recording or reproduction device; a housing or case for an appliance, computer, etc. In another embodiment, the first side of the molded composite has lower surface roughness than the second side of the molded composite.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A moldable nonwoven composite having a first side and a second side comprising:
a nonwoven face layer having an upper surface and a lower surface, wherein the upper surface of the nonwoven face layer forms the first side of the moldable nonwoven composite, wherein the nonwoven face layer comprises between about 80 and 95% wt first polyester terephthalate fibers and between about 5 and 20% wt first low melt polyester fibers, and wherein the nonwoven face layer has a weight of between about 150 and 750 g/m²;
an adhesive layer having an upper surface and a lower surface, wherein the adhesive layer is located on the lower surface of the nonwoven face layer such that the upper surface of the adhesive layer is adjacent the nonwoven face layer, wherein the adhesive layer comprises a first low melt polyester adhesive, and wherein the adhesive layer has a weight of between about 80 and 400 g/m²;
a sound absorbing nonwoven layer having an upper surface and a lower surface, wherein the sound absorbing layer is located on the lower surface of the adhesive layer such that the upper surface of the sound absorbing layer is adjacent the lower surface of the adhesive layer, wherein the sound absorbing nonwoven layer comprises between about 40-90% wt second polyester terephthalate fibers and between about 10 and 60% wt second low melt polyester fibers, and wherein the nonwoven face layer has a weight of between about 150 and 1,500 g/m²;
a polymer backing layer having an upper surface and a lower surface, wherein the polymer backing layer is located on the lower surface of the sound absorbing nonwoven layer such that the upper surface of the polymer backing layer is adjacent the lower surface of the sound absorbing layer, wherein the lower surface of the polymer backing layer forms the second side of the moldable nonwoven composite, wherein the polymer backing layer comprises a second low melt polyester adhesive, and wherein the polymer backing layer has a weight of between about 80 and 1,000 g/m²;
wherein the entire moldable nonwoven composite essentially consists of polyester, defined as being as least 95% wt polyester.

2. The moldable nonwoven composite of claim 1, wherein the nonwoven face layer comprises between about 85 and 92% wt first polyester terephthalate fibers and between about 8 and 15% wt first low melt polyester fibers.

3. The moldable nonwoven composite of claim 1, wherein the first and second polyester terephthalate fibers have a denier of about 3 to 15.

4. The moldable nonwoven composite of claim 1, wherein the first and second low melt polyester adhesives have melting temperatures of less than about 140° C.

5. The moldable nonwoven composite of claim 1, wherein the first and second polyester terephthalate fibers have a melting temperature of at least twice the melting temperature of the first and second low melt polyester fibers.

6. The moldable nonwoven composite of claim 1, wherein the adhesive layer at least partially extends into the lower surface of the nonwoven face layer and the upper surface of the sound absorbing nonwoven layer.

7. The moldable nonwoven composite of claim 1, wherein the sound absorbing nonwoven layer comprises between about 60 and 80% wt first polyester terephthalate fibers and between about 20 and 40% wt first low melt polyester fibers.

8. The moldable nonwoven composite of claim 1, wherein the sound absorbing nonwoven layer has an average thickness of between about 2 and 10 mm.

9. The moldable nonwoven composite of claim 1, wherein the sound absorbing nonwoven layer has a higher density than the nonwoven face layer.

10. A moldable nonwoven composite having a first side and a second side comprising:
a nonwoven face layer having an upper surface and a lower surface, wherein the upper surface of the nonwoven face layer forms the first side of the moldable nonwoven composite, wherein the nonwoven face layer comprises between about 80-95% wt first polyester terephthalate fibers and between about 5 and 20% wt first low melt polyester fibers, and wherein the nonwoven face layer has a weight of between about 150 and 750 g/m²;
a sound absorbing nonwoven layer having an upper surface and a lower surface, wherein the sound absorbing layer is located on the lower surface of the nonwoven face layer such that the upper surface of the sound absorbing layer is adjacent the lower surface of the nonwoven face layer, wherein the sound absorbing nonwoven layer comprises between about 40-90% wt second polyester terephthalate fibers and between about 10 and 60% wt second low melt polyester fibers, and wherein the nonwoven face layer has a weight of between about 150 and 1,500 g/m²;
a polymer backing layer having an upper surface and a lower surface, wherein the polymer backing layer is located on the lower surface of the sound absorbing nonwoven layer such that the upper surface of the polymer backing layer is adjacent the lower surface of the sound absorbing layer, wherein the lower surface of the polymer backing layer forms the second side of the moldable nonwoven composite, wherein the polymer backing layer comprises a second low melt polyester adhesive, and wherein the polymer backing layer has a weight of between about 80 and 1,000 g/m²;
wherein the entire moldable nonwoven composite essentially consists of polyester, defined as being as least 95% wt polyester.

11. The moldable nonwoven composite of claim 10, wherein the nonwoven face layer comprises between about 85 and 92% wt first polyester terephthalate fibers and between about 8 and 15% wt first low melt polyester fibers.

12. The moldable nonwoven composite of claim 10, wherein the first and second low melt polyester fibers have a melting temperature of less than about 200° C.

13. The moldable nonwoven composite of claim 10, wherein the first and second polyester terephthalate fibers have a melting temperature of at least twice the melting temperature of the first and second low melt polyester fibers.

14. The moldable nonwoven composite of claim 10, wherein the sound absorbing nonwoven layer comprises between about 60 and 80% wt first polyester terephthalate fibers and between about 20 and 40% wt first low melt polyester fibers.

15. A moldable nonwoven composite having a first side and a second side comprising:
a nonwoven face layer having an upper surface and a lower surface, wherein the upper surface of the nonwoven face layer forms the first side of the moldable nonwoven composite, wherein the nonwoven face layer comprises between about 80-95% wt first polyester terephthalate fibers and between about 5 and 20% wt first low melt polyester fibers, and wherein the nonwoven face layer has a weight of between about 150 and 750 g/m²;
an adhesive layer having an upper surface and a lower surface, wherein the adhesive layer is located on the lower surface of the nonwoven face layer such that the upper surface of the adhesive layer is adjacent the nonwoven face layer, wherein the adhesive layer comprises a first low melt polyester adhesive, and wherein the adhesive layer has a weight of between about 80 and 400 g/m²;
a sound absorbing nonwoven layer having an upper surface and a lower surface, wherein the sound absorbing layer is located on the lower surface of the adhesive layer such that the upper surface of the sound absorbing layer is adjacent the lower surface of the adhesive layer the lower surface of the sound absorbing nonwoven layer forms the second side of the moldable nonwoven composite, wherein the sound absorbing nonwoven layer comprises between about 40-90% wt second polyester terephthalate fibers and between about 10 and 60% wt second low melt polyester fibers, and wherein the nonwoven face layer has a weight of between about 150 and 1,500 g/m²;
wherein the entire moldable nonwoven composite essentially consists of polyester, defined as being as least 95% wt polyester.

16. The moldable nonwoven composite of claim 15, wherein the nonwoven face layer comprises between about 85 and 92% wt first polyester terephthalate fibers and between about 8 and 15% wt first low melt polyester fibers.

17. The moldable nonwoven composite of claim 15, wherein the first and second low melt polyester adhesives have melting temperatures of less than about 130° C.

18. The moldable nonwoven composite of claim 15, wherein the first and second polyester terephthalate fibers have a melting temperature of at least twice the melting temperature of the first and second low melt polyester fibers.

19. The moldable nonwoven composite of claim 15, wherein the adhesive layer at least partially extends into the lower surface of the nonwoven face layer and the upper surface of the sound absorbing nonwoven layer.

20. The moldable nonwoven composite of claim 15, wherein the sound absorbing nonwoven layer comprises between about 60 and 80% wt first polyester terephthalate fibers and between about 20 and 40% wt first low melt polyester fibers.
